(19) United States
(12) Patent Application Publication
(10) Pub. No.: US 2009/0061833 A1
(43) Pub. Date: Mar. 5, 2009

(54) SYSTEM, METHOD AND DEVICE TO USE MESSAGING TO IMPLEMENT PROGRAMMATIC ACTIONS

(76) Inventors: Junius Ho, San Francisco, CA (US); Christina Tseng, San Carlos, CA (US); Benoit Boningue, Mountain View, CA (US); Sachin Kansal, Sunnyvale, CA (US)

Correspondence Address: SHEMWELL MAHAMEDI LLP, 4880 STEVENS CREEK BOULEVARD, SUITE 201, SAN JOSE, CA, 95129-1034, US

(21) Appl. No.: 11/848,216

(22) Filed: Aug. 30, 2007

(51) Int. Cl. H04M 3/42

(52) U.S. Cl. 455/414.2; 455/466

(57) ABSTRACT

A mobile computing device may be configured to process a message may be incoming into or outgoing from the mobile computing device. A trigger may be detected in association with the message, and the trigger may be associated with an operation. The mobile computing device may automatically perform or initiate the operation in response to detecting the trigger.

### TECHNICAL FIELD

The disclosed embodiments relate to operations of a computer. More specifically, embodiments described herein relate to a system, method and device to use messaging to implement programmatic actions.

### BACKGROUND

Computing devices, particularly handheld and portable devices, have evolved to include numerous types of communication capabilities and functionality. For example, handheld devices exist that operate as cellular phones, messaging terminals, Internet devices, while including personal information management (PIM) software and photo-management applications. Additionally, Internet Protocol services exist that can transform Internet-enabled machines into telephony devices. Even stand-alone telephones that connect to traditional Public Switched Telephone Networks (PSTN) are including more software to enhance the telephone's functionality.

In enhancing communication capabilities and functionality, effort has been made to enhance and assist the user in using such devices. For example, software features exist to facilitate the ease in which the user can act on a phone number in an email message. A sequence of phone numbers can be presented to a user for selection, and upon such selection being made, a telephony application uses the phone number in making a phone call. Small form-factor computing devices, such as devices that provide cellular phone functionality, have particular use for such short-cut functionality, in order to reduce the manual involvement of the user. These devices have smaller keyboards that may be harder to operate, and/or use in mobile or dynamic environments, where the user cannot readily retrieve a desired number.

Telephony devices are just one type of communication device. There are now many types of communication types, and multi-functional devices exist to accommodate the different communication types. Examples of communication types other than telephony include email, instant message (including SMS protocol messages and Multimedia Message Service (MMS) protocol messages), and video conferencing. Many computing devices, particularly smart phones, are enabled to support communications using multiple communication mediums.

### BRIEF DESCRIPTION OF THE DRAWINGS

FIG. 1 is a simplified block diagram of a messaging system in accordance with an embodiment of the invention.

FIG. 2A illustrates an outgoing message having an embedded trigger, under an embodiment of the invention.

FIG. 2B illustrates an incoming message for use in a system for exchanging messages, in accordance with one or more embodiments of the invention.

FIG. 3 illustrates one embodiment in which pre-formulated text is used to specify a specific action that is to be performed or initiated, under an embodiment of the invention.

FIG. 4 illustrate use of pre-formulated text messages to incorporate and convey triggers, under an embodiment of the invention.

FIG. 5 illustrate an embodiment in which a system comprising a sending device and a receiving device coordinate to include location-based functionality in association with communication of a message between the sending and receiving device, under an embodiment of the invention.

FIG. 6 is a simplified diagram of a system for enabling receipt of incoming messages and/or transmission of outgoing messaging having function triggers, under an embodiment of the invention.

FIG. 7 illustrates a hardware diagram for a mobile computing device configured in accordance with one or more embodiments of the invention

### DETAILED DESCRIPTION

Embodiments described herein provide for messages, communicated amongst persons, to include programmatic triggers that cause a device or machine on either the sending or receiving end to perform a function. Under one or more embodiments, the triggers are provided as part of a header or body of a message, and are in the form of one or more characters, so as to comprise text data.

Among numerous applications, embodiments enable a device to respond to an incoming call by message replying the caller. The message reply may include a trigger that causes either the sending or receiving device to perform a function, such as a call back. On a cellular mobile computing device, the incoming call may be received by way of cellular telephony, such as over a voice channel. The user may reply with a message over, for example, Short Message Service (SMS) transport. The communicated SMS message may contain a trigger that initiates an action on either the device that received the call/sent the message or the device that placed the call/received the message. As described with other embodiments provided below, however, one or more embodiments may be incorporated with other forms of telephony, including Voice Over IP (VOIP) or proprietary protocols such as provided by SKYPE.

According to an embodiment, a mobile computing device includes processing resources, a memory that stores instructions and data, and a wireless communication sub-system. The processing resources use the instructions and data stored in the memory to enable a messaging application to be operable on the mobile computing device. The messaging application handles incoming messages received by the wireless communication sub-system and communicates outgoing messages over the wireless communication sub-system. A trigger detect component is configured to inspect an incoming message for presence of one or more triggers. One or more action components initiate or automatically perform an action responsive to the trigger detect component detecting a corresponding trigger.

In still another embodiment, a mobile computing device may be configured to process a message that may be either incoming into or outgoing from the mobile computing device. A trigger is detected in association with the message. The device associates the trigger with an operation. The mobile computing device may automatically perform or initiate the operation in response to detecting the trigger.

As a variation, the operation may be performed using data contained in the message, or data otherwise identified by the trigger.

Still further, a message may be stored in a computer-readable medium. The message may include a body of the message having a text content, and a data element included in a header or in the body of the message. The data element is structured to be recognizable, by a device that handles the message, as a trigger to initiate or automatically perform a function identified or associated with the trigger. In one implementation, the computer-readable medium may correspond to a cache, or other memory element where a message may be stored temporarily or before more permanent storage.

One or more embodiments described herein provide that methods, techniques and actions performed by a computing device are performed programmatically, or as a computer-implemented method. Programmatically means through the use of code, or computer-executable instructions. A programmatically performed step may or may not be automatic.

One or more embodiments described herein may be implemented using modules. A module may include a program, a subroutine, a portion of a program, or a software component or a hardware component capable of performing one or more stated tasks or functions. As used herein, a module can exist on a hardware component independently of other modules, or a module can be a shared element or process of other modules, programs or machines.

Furthermore, one or more embodiments described herein may be implemented through the use of instructions that are executable by one or more processors. These instructions may be carried on a computer-readable medium. Machines shown in figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on many cell phones and personal digital assistants (PDAs)), and magnetic memory. Computers, terminals, network enabled devices (e.g. mobile devices such as cell phones) are all examples of machines and devices that utilize processors, memory, and instructions stored on computer-readable mediums.

FIG. 1 is a simplified block diagram of a messaging system in accordance with an embodiment of the invention. A first mobile computing device 110 (“sending device 110”) is configured to send a second mobile computing device 120 (“receiving device 120”) a message 125, from which programmatic actions 140 may be triggered on one or both of the devices. The mobile computing devices 110, 120 may communicate across one or more networks, including cellular networks. One or both mobile computing devices 110, 120 may correspond to a portable and/or multi-functional devices having messaging capabilities across either voice or data channels. In one implementation, the mobile computing devices 110, 120 correspond to cellular telephony/messaging devices. The message 125 may be provided on any one of many possible transports, including Short Message Service (SMS), Multimedia Message Service (MMS), instant messaging, or email. Generally, on cellular devices, SMS and MMS transports are provided on voice channels, while email and instant messaging are provided on data channels.

The message 125 communicated from the sending device 110 may include a body 126, having text or other content. Additionally, the message 125 includes a trigger 130, which may be detectable by one or both devices. In one embodiment, the trigger 130 is detected and used by sending device 110, which processes the message 125 for triggers as an outgoing message. In another embodiment, the trigger is detected by the receiving device 120, which processes the message 125 for triggers as incoming. Still, the message 125 may include one or more triggers 130 that are used by both devices.

In one embodiment, the trigger 130 is provided in a header of the message, and may be carried in the form of text or characters. Alternatively, such a trigger may be carried in the body of the message. When the trigger 130 is detected, the detecting device programmatically initiates and/or performs a corresponding action 140. In an embodiment, the programmatic action 140 may be performed using data that is identified by the trigger and/or carried by the message 125. The programmatic action 140 may be performed automatically or semi-automatically. In one embodiment, programmatic action 140 is performed automatically, so as to be initiated and performed without user-input in response to the trigger being detected.

In another embodiment, the programmatic action 140 is initiated, but may require user-input to be completed. For example, the programmatic action 140 may prompt the user to elect to have the identified action fully performed. Upon the user's input (e.g. the user entering selection input confirming to have the action performed), the action 140 is performed.

According to an embodiment, trigger 130 directly identifies in the message 125 the data 128 that is to be used to perform the programmatic action 140. For example, one of the devices may be configured to use the trigger 130 to also locate or identify application data 128 for performing the programmatic action 140. The data 128 may be positioned, for example, adjacent the trigger 130, so that detection of the trigger also results in detection of the data 128. Similarly, the data 128 and trigger 130 may be combined into one data structure.

Still further, message 125 may carry data 128 independent of the trigger 130. For example, in one embodiment, the data 128 may be carried in the message header (or in the body of the message). The trigger 130 may invoke action 140 on one of the two devices, in which the second mobile device 120 (as receiver of message 125 incoming) performs the action of telephoning the sending device 110 using a phone number carried in the header of the message 125.

One or more embodiments also provide that the programmatic action 140 is performed without data that is identified by trigger 130 or included as part of the message 125. As an example, the trigger 130 may direct both devices 110, 120 to check voicemail. As another example, in the event the receiving device 120 is performing an activity, process or routine when the message is received, the trigger 130 may invoke action 140 in which receiving device 120 opens a folder and/or application where message 125 is stored immediately after it completes its in-progress routine/activity/process. For example, if receiving device 120 is on a phone call when message 125 is received, the receiving device may be configured to perform the action 140 of rendering the message 125 immediately after the phone call is over. Thus, the sending device 110 may include the trigger 130 that causes the message to be rendered as soon as the receiving device is available.

Numerous implementation examples may be provided with use of a system such as described in FIG. 1. In one embodiment, trigger 130 is processed to perform a delay notification by either the sending or receiving device 110, 120. For example, message 125 may carry the trigger 130 to direct the receiving device 120 to phone the sending device 110 in a given duration of time (e.g. ten minutes) has passed. In another embodiment, trigger 130 may direct either sending or receiving device 110, 120 to insert data in a record for use with another application. For example, the trigger action carried in the message 125 may be used to insert a line or data item in a calendar, task or memorandum entry.

Still further, the programmatic action 140 may correspond to an application, or a process that controls the application or initiates use of the application. In such an embodiment, trigger 130 may initiate use and/or control an application. Depending on implementation, either the sending device 110 or receiving device 120 may use trigger 130 in such context. In such embodiments, the detecting device may be configured to detect trigger 130 and use data 128 carried in the message 125 and/or identified by trigger 130. The programmatic action 140 caused by the trigger may include processes that launch the application and/or execution of the application using the data 128.

According to one or more embodiments, the trigger 130 and/or programmatic action 140 may be relevant or otherwise associated with a content of the message 125. In one embodiment, the body 126 includes a text message that is pre-formulated. The trigger 130 may be associated with the pre-formulated message, such that when the pre-formulated text message is selected by the sender 110, the associated trigger 130 is inserted to identify and trigger an associated action.

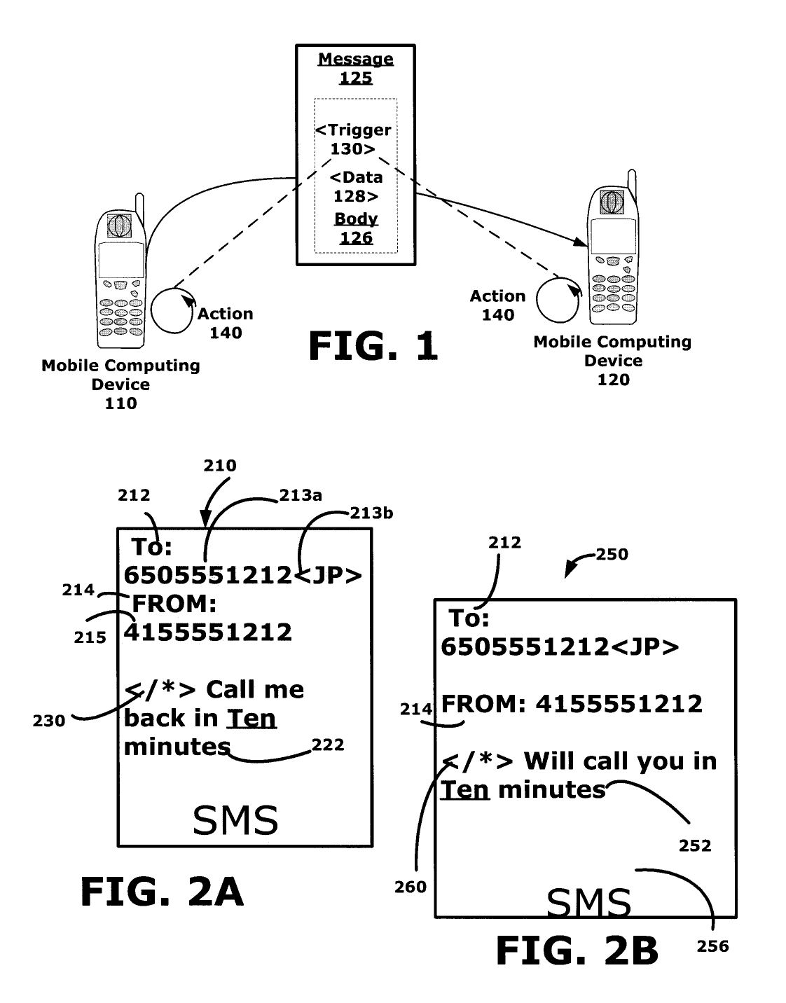

FIG. 2A and FIG. 2B illustrate messages that are structured in accordance with one or more embodiments. Messages such as described by an embodiment of FIG. 2A and FIG. 2B may be processed and stored in, for example, a cache or as part of memory used by a messaging program.

FIG. 2A illustrates an outgoing message having an inserted or embedded trigger, under an embodiment of the invention. In FIG. 2A, an outgoing message 210 is shown in the form of an SMS message that is either (i) in a state of composition, (ii) recently composed, or (iii) in process of transmission. As an example, the outgoing message 210 may be in the outbox folder. The message 210 includes “to” and “from” fields 212, 214 for identifying source and destination of the outgoing message 210. In the example provided, the “to” field 212 includes values 213a, 213b that identify a phone number and a name (or in this case an initial) of the intended recipient. The “from” field 214 also includes an identification value 215.

A body 226 of message 210 may include a text content 222. In one implementation, the text content 222 is a pre-formulated or “canned” message, meaning it is selectable and insertable as a whole into the message. The user may be able to select from a menu or list of pre-formulated text messages. With selection input, an entire message comprising several words or a phrase may be inserted into the body 226 of the message.

In an embodiment, trigger 230 is provided within the body 226 of the message. As outgoing, trigger 230 may be inserted by the sending device 110 (FIG. 1). Furthermore, under one implementation, trigger 230 may be used by the sending device 110. The sending device 110 may use the trigger to perform an action programmatically, and at least partially automatically. Thus, under an embodiment, one of the composition and/or transmission of the message may initiate a corresponding action on the sending device.

According to an embodiment, the trigger 230 may correspond to character data, such as special characters (e.g. “*/”), or alternatively a designated set of letters and/or numbers. In this form, the trigger 230 is text data and easily carried in any messaging transport, including SMS.

In an embodiment the trigger 230 is also associated with the pre-formulated text content 222. When the sending device 210 is to perform the action, the selection of the pre-formulated text content 222 may invoke a corresponding designated action on the sending device 110 (FIG. 1). As described with one or more embodiments of FIG. 4, different pre-formulated messages may be used to invoke different actions. One or more embodiments provide that the action associated with the trigger is relevant to the pre-formulated text content 222. For example, the text content 222 may state: “I will call you back” and the action performed on the outgoing device may be to prompt or initiate the phone call to the recipient device 120 after a designated duration or in response to a specific event. For example, in an implementation where the sending device is the detecting device, the call back action may be initiated on the sending device 110 right after the sender terminates another call that was in progress when the message 210 was communicated.

The trigger 230 may also be identified or associated with other data that is actually used by the sending device 110 (FIG. 1) to perform the action. For example, the trigger 230 may be associated with a value of the “To” field. More specifically, the trigger 230 may cause the sending device 110 to perform the action that uses the value 213a of the “To” field 212. Alternatively, the action triggered by the trigger may seek and use one of the values of the fields when it is performed

FIG. 2B illustrates an incoming message for use in a system for exchanging messages, in accordance with one or more embodiments of the invention. In FIG. 2B, an incoming message 250 may be an SMS message and may optionally correspond to the same message as the outgoing message 210 in FIG. 2A. Accordingly, the incoming message 250 may include the “to” and “from” fields 212, 214 for identifying source and destination of the outgoing message 210. As incoming, message 250 may be received on the receiving device 120 (FIG. 1) and forwarded to an inbox. In an embodiment of FIG. 2B, the receiving device 220 may detect and process a trigger 260, which causes the receiving device to automatically initiate and/or perform a corresponding programmatic action. As with an embodiment of FIG. 2A, the trigger 260 may, under one embodiment, be in the form of characters, including special characters, text or numbers.

A body 256 of the message 250 may include text content 252 that also contains the trigger 260. The trigger 260 may be provided with a pre-formulated text content 252. The pre-formulated text content 252 may be relevant to the action that is performed. For example, the user of the sending device 110 (FIG. 1) may select pre-formulated text content 252 to both communicate a message and direct the receiving device 120 (FIG. 1) to perform an action. For example, in one implementation, the sending device 110 is able to use trigger 260 to prompt the receiving device into making a phone call to the sending device after a designated duration of time. For example, the pre-formulated text content 222 may be equivalent to “Call me back in 10 minutes” and the action performed on the receiving device 120 (FIG. 1) may be to prompt the user to make the call after ten minutes.

The trigger 260 may identify or be associated with data that is to be used by the receiving device 120 (FIG. 1) in performing its action. For example, the trigger 260 may be associated with one of the fields, such as the “from” field 214. Alternatively, the action triggered by the trigger may seek and use one of the values of the fields when it is performed. In such an example, the action performed as a result of the trigger 260 may incorporate or use the phone number of the “from” field 214.

Pre-Formulated Messages

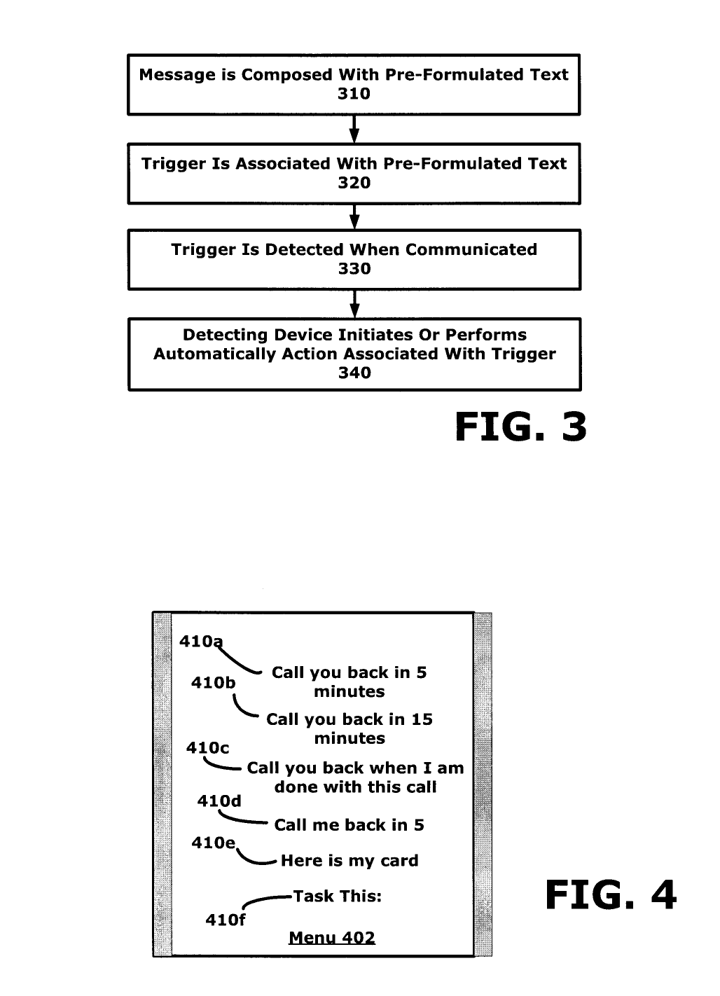

FIG. 3 illustrates one embodiment in which pre-formulated text content of a message is used to trigger a specific action that is to be performed or initiated when the message is communicated, under an embodiment of the invention. In describing a method of FIG. 3, reference is made to elements described in a system of FIG. 1, for purpose of illustration suitable elements or sub-elements for performing a step or portion thereof. In step 310, an event occurs or is in progress when a user on sending device 110 composes an outgoing message. In composing the message, the user may select one pre-formulated text message from other pre-formulated text messages. With selection, text content corresponding to the pre-formulated text message is inserted into a body of the message. An example of an event may correspond to a device receiving an incoming call. The method described may be implemented in the context of message replying the caller, as a substitute for answering the call.

In step 320, a trigger may be associated with the pre-formulated message. Each trigger may invoke a corresponding action. Furthermore, different pre-formulated messages may contain different triggers. As described with an embodiment of FIG. 2A, the pre-formulated text message may be associated with a particular set of characters, such as special characters, that are identifiable as a trigger to a detecting device. Optionally, the trigger provided with the pre-formulated message may include a trigger identification, to identify one trigger (and thus a programmatic action) from other triggers and programmatic actions.

In step 330, the trigger is detected when the message is communicated. In one embodiment, the trigger is detected and used by the sending device. For example, the trigger may invoke a delayed action (e.g. notification or application launch or use) on the sending device 110. In another embodiment, the trigger is detected and used by the receiving device 120. Still further, both devices may detect and use the trigger in one message exchange.

The process of detecting the trigger may be one where the body of the message (whether incoming or outgoing) is scanned for presence of characters that identify the trigger. Thus, the detecting device may include logic for scanning messages of the particular transport used to convey the trigger (such as SMS). As an alternative to special or designated characters, the detecting device may use pattern recognition of the text body. For example, a pre-formulated text message may be recognized from the words used, even if other words appear before or after the message.

Still further, the trigger may be event-based. The detecting device may include logic that detects a condition or device state, and infers the trigger based on the presence of the condition. For example, the receiving device may detect a trigger (i) if that device has just placed a call to a particular number, and (ii) an SMS message is received within a designated duration of time from the same phone number of the incoming caller. The presence of these two conditions may infer a “message ignore scenario” where one device may ignore an incoming message with a message reply (such as by way of SMS).In such instances, for example, the receiving device may scan the message for a field value that indicates a duration of time (“5 minutes”), and then may perform an action or notification in that time period.

Step 340 provides that the detecting device either initiates or performs automatically the action identified by the trigger. If the detecting device initiates performance of the action, it may display to the user a question or other prompt to confirm the device should perform the action. For example, the action may correspond to calling a number included in the “to” or “from” field (depending on whether the detecting device is the recipient or sender of the message). Upon receiving the confirmation input from user, the action (e.g. placing the call) may be performed. Alternatively, the action may be performed automatically. For example, the detecting device may place the call immediately, after a given duration designated by the trigger or action, or after an event (such as termination of a call in progress).

FIG. 4 illustrate use of pre-formulated text messages to incorporate and convey triggers, under an embodiment of the invention. FIG. 4 illustrates an embodiment in which a user can select pre-formulated text messages 410 from a menu 402 for transmission to another device, where actions associated with the message are to be performed on the sending device. Messages 410a-410c may be implemented in a call-ignore scenario, where the user is able to message reply an incoming call, rather than answer the call. The messages 410a-410c enable the user to select a particular duration of time. The trigger associated with each message 410a-410c may invoke the sender to perform the call back, using the time specified in the content of the message. Thus, both the specific action (placing the call) and the timing as to when the action is to be performed may be specified by the trigger of the pre-formulated text message.

As an alternative or addition, the timing as to when the action is to be performed may be supplied as input by the user of the sending device. Under one embodiment, the pre-formulated message may present a field that the user can fill in with a numeric value. The action performed in association with the message may scan for the field value and delay (or otherwise configure or modify) performance of the action based on the field value.

Message 410d provides an example of a sender specifying a programmatic action on the recipient device. Message 410d may also be provided in context of a call-ignore event. However, message 410d may include a trigger that specifies the recipient device to perform the call back (or initiate the call back) after a given duration of time. As an alternative or addition, the user of the sending device may specify the value when the call back is to be performed. Thus, the pre-formulated message 410d may provide text content and trigger with an open field that can be supplied manually with user-input. Under one implementation, the value of the user-input may affect the trigger and/or action to be performed. For example, the timing of a delay notification may be affected by the user-input.

Numerous alternative actions may be associated with pre-formulated messages. Message 410e shows an example where the composition and/or transmission of the message causes both the sender and recipient device to perform an action. In message 410e, the user's selection of the pre-formulated text message “Here is my card” may cause one or both of the following: (i) the sender device to automatically attach the sender's contact information or v-card, and (ii) have the information or card stored in a contact application on the recipient device.

Message 410f shows another implementation where the sender may select a pre-formulated text message that invokes the recipient device to store the message as a task or memo. An actual task item may be entered manually by the user. Under one implementation, the text of the task item is carried into task or memo as part of the action performed (responsive to the trigger).

In any of the examples provided by FIG. 4, the corresponding action may be performed by the acting device having logic to (i) detect the trigger embedded or included in the body of the message, and (ii) perform the action identified or otherwise associated with the trigger. In an embodiment in which SMS transport is used, the sending device 110 may be configured to insert the trigger automatically when a corresponding pre-formulated message is selected and inserted into the body of the message. Such a trigger may be inserted as text data (e.g. special characters, such as “*/”) into the body of the message. Depending on the implementation, the sending and/or receiving device may be configured to detect the presence of the trigger, and then either perform the action, or alternatively initiate performance of the action.

As an alternative or addition, the sending device 110 (FIG. 1) may recognize and perform a function associated with a composed or outgoing message simply be detecting the selection of the pre-formulated message. Thus, the sending device may operate without triggers embedded or provided within the body of the message. Rather, the trigger may correspond to the user of the device selecting a particular pre-formulated message.

Location-Based Functions

One or more embodiments provide for use of messages to trigger performance of location-based functions. Location-based functions may correspond to functions that integrate location information, in any particular form, such as by way of coordinates (e.g. through use of GPS component) or street address.

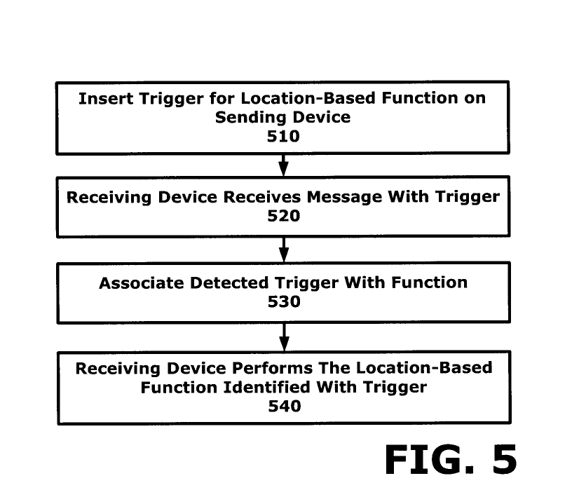

FIG. 5 illustrate an embodiment in which a system comprising a sending device and a receiving device coordinate to include location-based functionality in association with communication of a message between the sending and receiving device, under an embodiment of the invention. In describing a method of FIG. 5, reference is made to elements of a system of FIG. 1, for purpose of illustrating suitable elements for performing a step (or sub-step) being described.

In step 510, the sending device 110 is operated to insert a trigger for location-based functionality into a message. The message may be of a kind used under any transport, such as SMS. The trigger may be operated by the user performing an action that is associated with insertion of the trigger. For example, the user may select a pre-formulated text that pertains to location-based functionality (e.g. “Where are you?”). Selection of the text may automatically insert a trigger into the header or body of the message. The trigger may be used by the recipient device 120. Under an embodiment, the trigger may also be used by the sending device 110.

In one embodiment, insertion of the trigger may occur responsive and/or in connection with insertion of location-based information, such as provided from GPS resources that may be resident on the device. For example, under one implementation, the user may select a pre-formulated text (e.g. “where are you”). The selection of the pre-formulated message, or the inclusion of a trigger associated with that message, may also trigger the sending device 110 to use the GPS resources to identify coordinates of the sending device for insertion into the header or body of the message. As will be described, the insertion of GPS coordinates of the sending device may be used to enable the receiving device 120 to (i) estimate a measure of separation between the two devices, or (ii) map the position of the sending device in preparing a response answer.

As another example, the user of the sending device may communicate the message: “Meet me here”. The inclusion of the message may include a trigger, or otherwise separately trigger the sending device to include coordinates from GPS resources, or information about the location of the user from a mapping service. Thus, the composition of the message may separately trigger the sending device 110 to include supplemental information from the GPS resources.

As an alternative, the user of the sending device may operate the GPS resources to direct the GPS resources to programmatically insert the information into the body of the message. As still another variation, the user of the sending device 110 may select the pre-formulated message and manually supplement the message with information about the location of the user into the message. For example, the user may operate a separate GPS device, operate the GPS application of the detecting device independently, or enter location information in the form of a steet address or zip-code. The information may be carried as entered by the user of the sending device. Alternatively, once the location information is entered and the communication of the message is initiated (e.g. the message is placed in the outbox), the trigger in the message causes the sending device 110 to access the GPS resources and programmatically convert the entered information into a form of data that can be used by the GPS resources of the receiving device.

In step 520, the receiving device 120 receives the message. The device may be configured to process the message for triggers. For example, the receiving device 120 may scan the header or body of the incoming message for a designated set of characters that are indicative of a trigger. As an alternative, the trigger may be combined by the presence of numbers and characters that match a form of coordinates from a GPS application. Still further, presence of other words or data element types may act as a trigger. For example, the presence of the word “address” or the detection of a string of characters that appear to be an address (e.g. string including 1-4 numbers at beginning, followed by words and ending with various words or abbreviation indicative of road, street etc.) may all be determined to be location information by the detecting device. Other variations are also possible. As mentioned, the trigger may be provided as a header or in the message body.

Step 530 provides that the receiving device 120 associates the detected trigger with a function. The receiving device 120 may also handle the message in a manner in which messages of the SMS (or other) transport are normally handled. For example, the message may be stored as a new message in an inbox folder.

Step 540 provides that the receiving device performs the identified function associated with the detected trigger. The identified function may be performed immediately or subsequently, after a duration of completion of an event. The trigger may cause the receiving device to either perform the action automatically, or to initiate the action. For example, the trigger may cause the receiving device 120 to prompt the user for confirmation input before completing the action.

According to an embodiment, the action that is performed requires identification of location information of the receiving device 120. As an alternative or addition, the action may require the receiving device to access its GPS resources. For example, the action may include the receiving device determining its coordinates to identify its location.

Still further, the action that is to be performed on the receiving device may include the use of data provided in the received message. For example, the action may use coordinates provided in the incoming message with a mapping application, so that the recipient device generates a map from information contained in the message. As another example described (in more detail with the following paragraph), the action may require use of location information of the sending device for purpose of determining a distance measurement between the two devices. The trigger may be provided to identify the location-information. Alternatively, the logic that performs the action on the receiving device 120 may detect the location information in the incoming message based on, for example, data format or pattern recognition.

Under one embodiment, the action performed by the receiving device may also include the receiving device 120 processing the GPS information from the sending device 110. Thus, for example, the receiving device 120 may determine a difference between the position of the sending and receiving devices 110, 120. This difference may correspond to distance and/or time measurement (e.g. “You are 8 minutes away at current speed.”).

The action performed by the receiving device 120 in response to receiving the triggered message may also be multi-stepped. For example, the receiving device may also be configured to perform the action of sending a reply message back to the sending computer. Depending on the embodiment, the reply message may include the location information of the recipient device 120 (as determined by the GPS resources of the device 120) and/or evaluation of location information of the sending device 110 (if any present).

An embodiment such as recited with FIG. 5 may be implemented to initiate or trigger actions that announce or relate to a delayed arrival of a user carrying a mobile computing device. In one implementation, GPS resources on a device may detect its position, and that information may in turn be used to communicate delayed arrivals. For example, a person may communicate an outgoing message from one mobile computing device to another device having GPS resources, to the effect of “Call me when you get home.” A trigger in the message may initiate the receiving device to (i) programmatically determine when the device is ‘home’, and (ii) initiate or place the call for the user. In another implementation, the device may communicate a message consistent with “I will call you from home”. The device may process the outgoing message to detect when it is home, and then programmatically initiate or place the call.

System Architecture

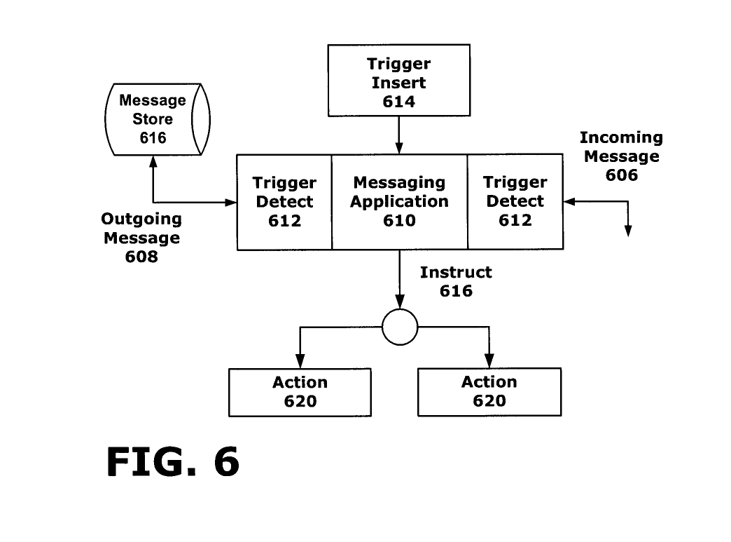

FIG. 6 is a simplified diagram of a system for enabling receipt of incoming messages and/or transmission of outgoing messaging having function triggers, under an embodiment of the invention. A system 600 such as described with an embodiment of FIG. 6 may be implemented on, for example, a mobile computing device (e.g. cellular messaging/voice device), although embodiments may be implemented on numerous different types of devices, such as multi-functional portable computing devices, laptop computers and desktop computers. A system such as described by an embodiment of FIG. 6 may be implemented using a combination of components and/or modules, including a messaging application 610 having one or more trigger detect components 612 and/or a trigger insert component 614. The messaging application 610 may communicate with one or more action components 620. A message store 615 may be maintained and used by the messaging application 610.

In an embodiment, a device on which system 600 is provided may use wireless communication mediums, such as provided by cellular mediums, to send and receive messages. Alternatively, the device may use Wireless Fidelity (“WiFi”) as defined by, for example, the 802.11(b) or 802.11 (g) standards, or even WiMax networks that operate under the 802.16 standards. Land connections may also be used. While different messaging transports may be used with embodiments described herein, one or more embodiments provide for system 600 to be implemented for SMS transport, using a cellular network or other network that can handle SMS messaging.

With regard to an incoming message 606, system 600 may process the message by inspecting the message for a trigger. In one embodiment, the trigger detect 612 inspects the incoming message 606 by scanning the header and/or body of the message for the presence of the trigger. With SMS messages which carry text, the trigger detect 612 scans the message for text that is characteristic of a trigger. For example, the message may be scanned for a cluster of special characters that are indicative of a trigger. As an alternative or addition, trigger detect 612 may scan the message for text patterns that are indicative of a particular function, such as may be provided with a pre-formulated message. In one embodiment, trigger detect 612 scans the incoming message 606 for characters that are indicative of the trigger, and then removes the characters from the message before the messaging application 610 subsequently stores and/or renders the incoming message 606. In one embodiment, the messaging application 610 stores the incoming message 606 in the message store 615 (e.g. “inbox”), and sends an instruct 616 or other signal to one of the action components 620.

In one embodiment, the messaging application 610 also identifies data for performing the action identified by the trigger from the incoming message 606. The messaging application 610 may, for example, identify data from the header of the message, or data included with or identified by the trigger. The messaging application 610 may communicate the identified data to the action component 620.

The action components 620 may correspond to applications, plug-ins, or software and/or other logic that uses the instruct 616 and/or identified data to perform the function associated with the trigger. For example, the action component 620 may correspond to anyone of an application (or plug-in) corresponding to a phone application (for when the action is to place a call), a mapping application (for performing location-based functions in the form of mapping), a GPS application that interfaces with corresponding GPS hardware (for performing location-based functions), task manager, file manager, or notification manager for generating instant and delayed notifications.

As an alternative or addition, system 600 may also be configured to (i) insert triggers into an outgoing message, and optionally (ii) process triggers in outgoing messages. As mentioned, the outgoing message 608 may be one that is composed, placed in a folder (e.g. “outbox”) for transmission, or in a state of transmission. Trigger insert 614 may correspond to a component that places, for example, a character or set of characters that identify a particular function in the header or body of a message that is to be outgoing. The trigger insert 614 may be integrated with the messaging application 610, or provided separately from it.

In one implementation, for example, the trigger insert 614 is associated with a menu or list of pre-formulated messages. The selection of a message from the list results in the trigger insert 614 inserting a corresponding trigger for the selected message in the header or body of the outgoing message 608. As an alternative or addition, trigger insert 614 may be associated with a GPS application. The use of the GPS application in certain instances may generate data that may be inserted into the message as or with a separate identifiable trigger. Numerous other forms of trigger inserts may be used.

As mentioned, an embodiment provides that the system 600 is configured to detect and act on triggers in outgoing messages. Trigger detect 612 may thus scan the outgoing message 608, including the header and body for presence of the trigger. Alternatively, the trigger insert 614 may communicate with the messaging application 610 to signal the presence of a trigger. The trigger may then be acted on by one of the action components 620. For example, the messaging application 610 may provide an instruct 616 for the outgoing message 608, which may be handled and processed by, for example, a notification component (generate a delayed notification) or telephony application (place a call to recipient device at a later time).

Hardware Diagram

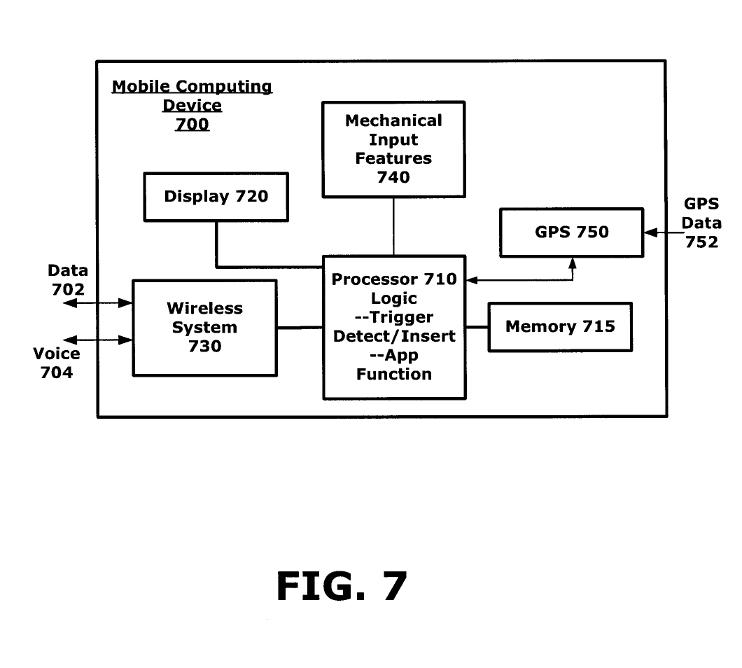

FIG. 7 illustrates a hardware diagram for a mobile computing device configured in accordance with one or more embodiments of the invention. A device 700 includes a processor 710, memory resources 715, a display 720, a wireless communication sub-system 730, and mechanical input features 740. The wireless communication sub-system 730 may send and receive wireless data over data channels 702 and voice channels 704. Messages over SMS and MMS transports are communicated over voice channels 704. Emails and instant messages are communicated over data channels 702.

Processor 710 may be configured with software and/or other logic to perform one or more processes, steps and other functions described with embodiments. Processor 710 is configured, with instructions and data stored in memory resources 715, to execute messaging application 610 (see FIG. 6), as well as components for trigger detect 612 (FIG. 6) and trigger insert 614 (FIG. 6). The incoming and outgoing messages may be received or transmitted from the wireless sub-system (which may or may not include processor 710). For location-based functions, processing resource 710 may execute a GPS application and use an integrated GPS sub-system 750 that handles receipt of GPS data 752.

While FIG. 7 is illustrated for a mobile computing device, one or more embodiments may be implemented on other types of devices, including multi-functional devices, or full-functional computers such as laptops.

### Alternative Embodiments

While embodiments described herein provide for use of incorporating or embedding triggers with messages, other embodiments provide for coordinating performance of certain actions with communication of specific messages. One or more embodiments may be implemented in the context of providing message replies to incoming phone calls. More specifically, U.S. patent application Ser. No. 11/200,511 (hereby incorporated by reference) describes a device that enables a user to respond to an incoming phone call with a message reply to the caller. For example, the user may elect to ignore an incoming call by text messaging the caller to call back. In this context, one or more embodiments provide that a user of a mobile computing device can, with one or more short-cut actions, answer an incoming phone call and place it on hold, while messaging the caller back and informing him that is he or she is on hold. For example, in response to an incoming call, the user can select a pre-formulated message that states content to the effect of “You are on hold, Please wait.” When the pre-formulated message is selected, the answering device (where the message is composed) also performs, for example, actions of (i) answering the incoming call and (ii) placing it on hold. Thus, the act of selecting the particular “on hold” message may trigger the device to answer a call and place it on hold.

As an alternative or addition to embodiments described herein, a user may perform an action that triggers both the selection of text content (e.g. through the selection of a pre-formulated text message) and concurrent programmatic actions. For example, rather than the user selecting a pre-formulated message to trigger an incoming call to be placed on hold, the user may provide a single input that (i) composes and sends the pre-formulated message (e.g. “hang on, placing you on hold”), then (ii) answers the call and (iii) places it on hold. For example, the user may be prompted with a message in response to an incoming call. The message may ask the user as to whether he or she wishes to place the call on hold and message reply the user. If the user selects the action of the prompt, the message is sent and the call is answered and placed on hold.

In still another embodiment, a pre-formulated text message may be provided without triggers or associated functionality, but as a form, with one or more fields that the user can fill in. Such a pre-formulated message may be used, for example, to message response incoming calls. Such forms may be incorporated into SMS or MMS messaging applications.

Still further, embodiments described herein provide for a mobile computing device that is configured to incorporate triggers for use in message replying responses to incoming phone calls. In one embodiment, a mobile computing device may be configured to enable the user of a mobile computing device to message reply a caller. The mobile computing device may further be configured to programmatically detect a trigger in association with the message. In response to detecting the trigger, the device automatically performs the operation that is associated with the trigger.

Under one variation, and as mentioned with one or more other embodiments, the message reply may invoke or trigger an operation that requires use of data contained in the body of the message.

Usage Scenarios and Alternatives

One or more embodiments provide for message replies to incoming telephony calls. On a cellular mobile computing device, for example, an incoming cellular telephony call to a first device may result in an application executing on the receiving device to prompt the user to message-reply the caller. If the user elects to message-reply the caller, a particular messaging application may partially compose a new outgoing message. For example, the SMS application or plug-in open a new message and insert the phone number of the caller into the address field, and have the message ready to receive text content for its body. The user may then be prompted with a list of possible message replies, of which some (or all) may include triggers. The list of possible message replies may, for example, be represented by an embodiment of FIG. 4. Once the message reply is inserted, the message and its trigger may be handled consistent with any of the embodiments described herein. For example, both the sending and receiving device may process the trigger to implement some immediate or delayed programmatic action (e.g. notification, call placement etc.).

As an alternative to conventional cellular telephony, the devices may communicate using “Voice Over IP” (VOIP) communications. Thus, one device may place a VOIP call to another device, and the device receiving the incoming call may message reply the caller back with a message that is structured in accordance with embodiments described herein. The devices using VOIP may be connected devices, in communication with the Internet or other public networks through the use of high-speed network connections. However, an embodiment such as described may also apply to mobile computing devices that use cellular data channels to perform VOIP Telephony. With VOIP telephony, one or more embodiments provide that message replies (with triggers) are carried over transports such as e-mail or Instant messaging.

As mentioned elsewhere, embodiments described herein may also be implemented outside of the content of message-replies to incoming calls. In one embodiment, an initiating computing device (e.g. mobile cellular telephony device) may send messages to multiple participants who operate other devices, using, for example, an SMS message transport. The messages may be sent independent of any call that the sender is on. Each message may include a common trigger that identifies a time, date and a phone number for a conference call to take place. Additional information, such as the subject of the meeting, or the conference code, may be included in a body of the message. The receiving devices process the incoming messages programmatically. At or before the given time and date, each receiving device (and the sending device) may perform one or more of the following: (i) provide a reminder notification of a scheduled conference call; (ii) provide a notification as to when the conference call is to initiate; (iii) prompt the user into initiating programmatic steps for placing the device on the call, including dialing the number or using the conference code; and (iv) perform some or all of the actions needed to place the user on the conference call (including dialing the number and the conference code). Under one implementation, all of the recited steps are performed automatically. Moreover, while the usage scenario recites a cellular device, other embodiments contemplate use of desktop or laptop machines, which may use VOIP and/or other forms of messaging transports (such as email or instant messaging).

Although illustrative embodiments of the invention have been described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. This, the absence of describing combinations should not preclude the inventor from claiming rights to such combinations.

What is claimed is:

1. A method for performing a location-based function, the method comprising:
receiving an incoming message;
detecting location information in a header or a body of the incoming message; and
in response to detecting the location information, automatically performing the location-based function using the location information.

2. The method of claim 1, wherein detecting location information includes detecting a trigger that indicates a presence of the location information.

3. The method of claim 2, wherein the trigger is a designated set of characters.

4. The method of claim 3, wherein the designated set of characters corresponds or identifies a pre-formulated text message.

5. The method of claim 1, wherein receiving the incoming message includes receiving one of a Short Message Service (SMS), an instant message, an email, or a Multimedia Message Service (MMS) message.

6. The method of claim 1, wherein detecting the location information includes detecting a set of coordinates for use with a global positioning system component.

7. The method of claim 6, wherein performing the location function includes executing a process of a global positioning system application using the set of coordinates.

8. A method for performing a location-based function on a mobile computing device, the method comprising:
detecting an outgoing message;
detecting a trigger for performing a location based function;
responsive to detecting the trigger, performing the location based function to generate a result;
including data corresponding to the result in the outgoing message.

9. The method of claim 8, wherein detecting an outgoing message includes detecting one of a Short Message Service (SMS), an instant message, an email, or a Multimedia Message Service (MMS) that is in composition or ready for transmission.

10. The method of claim 8, wherein detecting a trigger includes detecting inclusion of a designated set of characters in the body of the outgoing message.

11. The method of claim 8, wherein performing the location based function includes determining information about a location of the mobile computing device, and wherein including data corresponding to the result includes programmatically inserting data corresponding to the location in the outgoing message.

12. A message stored in a computer-readable medium, the message comprising:
a body of the message having a text content;
a data element included in a header or in the body of the message that is recognizable, by a device that handles the message, as a trigger to initiate or automatically perform a function identified or associated with the trigger.

13. The message of claim 12, wherein the trigger corresponds to a set of one or more characters.

14. The message of claim 12, wherein the message is one of a Short Message Service (SMS) or Multimedia Message Service (MMS) type message.

15. The message of claim 12, wherein the text content is a pre-formulated message.

16. A method for performing messaging operations on a mobile computing device, the method comprising:
for a message that is incoming into or outgoing from the mobile computing device, detecting a trigger in association with the message;
associating the trigger with an operation; and
automatically performing the operation in response to detecting the trigger, using at least in part, data contained in the message.

17. The method of claim 16, wherein detecting a trigger includes detecting the trigger from a data element contained in a header or a body of the message.

18. The method of claim 16, wherein the data element corresponds to a designated set of characters.

19. The method of claim 18, wherein detecting the trigger further comprises detecting the designated set of characters in association with a pre-formulated text message.

20. A mobile computing device comprising:
processing resources;
a memory that stores instructions and data;
a wireless communication sub-system;
wherein the processing resources use the instructions and data stored in the memory to enable:
a messaging application to be operable on the mobile computing device, wherein the messaging application handles incoming messages received by the wireless communication sub-system and communicates outgoing messages over the wireless communication sub-system;
a trigger detect component that is configured to inspect an incoming message for presence of one or more triggers;
one or more action components that initiate or automatically perform an action responsive to the trigger detect component detecting a corresponding trigger.

21. The mobile computing device of claim 20, wherein the processing resources enable a trigger insert component that inserts a trigger into an outgoing message for causing another device receiving the outgoing message to initiate or automatically perform a corresponding action.

22. The mobile computing device of claim 20, wherein the processing resources enable the trigger detect component to inspect an outgoing message for presence of another trigger, and wherein another action component is configured to initiate or perform an action identified by the detected trigger of the outgoing message.

23. The mobile computing device of claim 20, wherein the messaging application is for either a Short Message Service (SMS) or Multimedia Message Service (MMS) transport.

24. The mobile computing device of claim 20, wherein the one or more action components use data provided in the incoming message to initiate or automatically perform the action.

25. The mobile computing device of claim 24, wherein the data provided in the incoming message is location information provided by a Global Positioning Resource, and wherein the action is a location-based function.
